(19) United States
(12) Patent Application Publication
(10) Pub. No.: US 2005/0157897 A1
(43) Pub. Date: Jul. 21, 2005

(54) Hearing instrument

(76) Inventor: Oleg Saltykov, Fairlawn, NJ (US)

Correspondence Address: Alexander J. Burke;SIEMENS CORPORATION, 170 WOOD AVENUE SOUTH, ISELIN, NJ, 08830, US

(21) Appl. No.: 10/356,986

(22) Filed: Feb. 3, 2003

Related U.S. Application Data
(60) Provisional application No. 60/366,005, filed on Mar. 20, 2002.

(51) Int. Cl. H04R 25/00

(52) U.S. Cl. 381/322; 381/323; 381/324; 381/328

(57) ABSTRACT

The invention is directed to a hearing instrument for positioning in the ear of a user, incorporating a faceplate having first and second spatially separated sound openings for receiving sound to be provided to respective inlets of a microphone; at least one screen partially blocking the sound openings and positioned to increase effective distance between the first and second spatially separated sound openings; and a housing for containing the microphone, the housing having the faceplate mounted thereon and being sized to fit within the ear of a hearing instrument wearer.

This is a non-provisional application of provisional application Ser. No. 60/366,005 by Oleg Saltykov, filed Mar. 20, 2002.

### BACKGROUND

1. Field of the Invention

The field of the invention concerns hearing instruments, and particularly hearing instruments with directional microphones.

2. Description of the Prior Art

Conventional hearing instruments typically comprise a single omni-directional microphone, which amplifies sound substantially equally from all directions. Because of the omni-directional nature of these hearing instruments, it is often difficult for the wearer to distinguish between a speaker's voice and background noise. Hearing instruments have therefore been developed that accentuate a speaker's voice over background noise.

Directional microphones may be implemented in hearing aids in several ways. In one system, two or more omnidirectional elements are linked to two or more individual ports. One microphone is linked to each port, and electrical signals are processed in order to extract the directional response. Alternatively, one or more directional elements may be linked to two or more ports. One directional microphone is linked to two ports, and the signal is processed by the directional element. The difference in sound intensity on the closely-positioned ports of this type of directional hearing aids is typically negligible and the information about the direction of arriving sound signals is derived from the phase differences of the sound signals.

However, directional microphones, although suitable for isolating a speaker's voice, typically have signal-to-noise ratios less than that of omni-directional microphones. Also, directional microphones are very sensitive to wind noise. Thus, in environments with little background or high wind noise, an omni-directional microphone is more desirable for use in processing sound. Therefore, hearing instruments have been developed that include both an omni-directional and a directional microphone, wherein a wearer switches between the two modes as desired.

Unfortunately, hearing instruments that contain both an omni-directional microphone and a directional microphone typically have lower sensitivity in the directional mode and are larger in size as compared to hearing instruments containing only an omni directional microphone. These dual mode hearing instruments generally have two separate microphone cartridges and a separate toggle switch for switching between them. The total space occupied by these components limits their use to users with ears large enough to accommodate the devices. An unfortunate result is that children often cannot make use of these larger devices.

Accordingly, the hearing instrument industry seeks reduced sized hearing instruments with improved sensitivity and simplified assembly, yet having the advantages of both omni-directional and directional functionality.

### SUMMARY OF THE INVENTION

Embodiments of the invention include a hearing instrument for positioning in the ear of a user, incorporating a faceplate having first and second spatially separated sound openings for receiving sound to be provided to respective inlets of a microphone; at least one screen partially blocking the sound openings and positioned to increase effective distance between the first and second spatially separated sound openings; and a housing for containing the microphone representing the received sound, the housing having the faceplate mounted thereon, the housing being sized to fit within the ear of a hearing instrument wearer and containing the microphone.

### BRIEF DESCRIPTION OF THE DRAWINGS

The invention is best understood from the following detailed description when read with the accompanying drawings.

FIG. 1 is a drawing illustrating a cross-sectional view of a preferred embodiment of a microphone section of a hearing instrument.

FIG. 2 is a drawing illustrating a top view of a preferred embodiment of a microphone component.

FIG. 3 is another drawing illustrating a cross-sectional view of a preferred embodiment of a hearing instrument.

FIG. 4 is a picture illustrating a preferred embodiment of a hearing instrument.

### DETAILED DESCRIPTION

The invention will be understood more fully from the detailed description given below and from the accompanying drawings of preferred embodiments of the invention; which, however, should not be taken to limit the invention to a specific embodiment but are for explanation and understanding.

A hearing instrument in accordance with a preferred embodiment of the invention includes a microphone component having directional and omni-directional functionality. The directional cartridge is preferably assembled with the omni-directional cartridge. A gasket, preferably made of a pressure-sensitive adhesive, may be used to achieve sealing and acoustic leak prevention in the device. One or more windscreens may also be used to cover a portion of the faceplate of the hearing instrument to increase the effective distance between the front and rear receiving ports, which provides for a higher sensitivity in the directional mode.

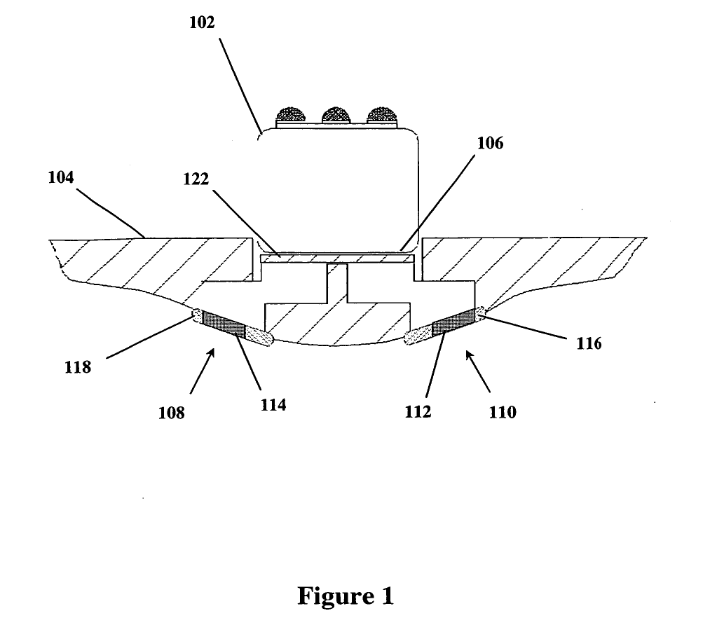

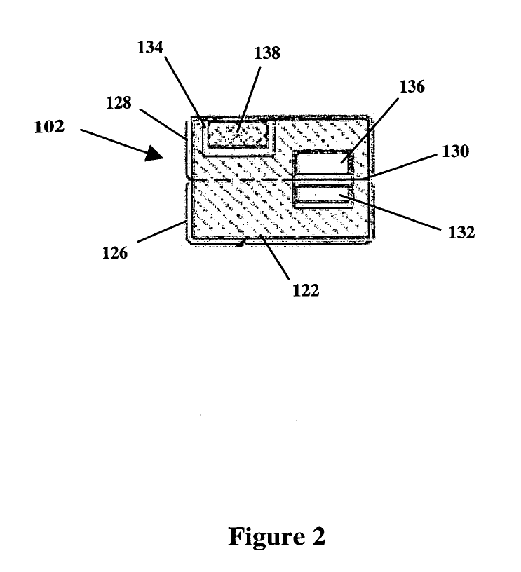

FIG. 1 depicts a cross-sectional view of a hearing instrument device according to one preferred embodiment of the invention. A microphone component 102 may be at least partially embedded in a faceplate 104. In an exemplary embodiment, microphone component 102 is in cartridge form. Inlets to microphone component 102 may be included on a microphone component surface 106, as further described in connection with FIG. 2. The illustrative example depicted in FIG. 1 has surface 106 perpendicular to the plane of the page. Surface 106, however, may be any surface of microphone component 102 on which the inlets may be positioned.

A front port 108 and a rear port 110 may be positioned in faceplate 104 to allow sound to travel to the microphone component inlets. (The terms “front” and “rear” are used herein to facilitate understanding of the invention. The terms, however, do not limit the invention to particular relative configurations, and are merely used for illustration.) The distance between the front and rear ports is preferably in a range of about 5 mm to about 12mm, although not limited thereto.

Windscreens 116 and 118 may also be included. Windscreens 116 and 1 18 preferably extend across ports 110 and 108 and the microphone component inlets. Windscreens 116 and 118 may contain holes 112 and 114 (e.g., perforations) and partially obstruct the ports, therefore increasing the effective distance between ports 108 and 110. The windscreens may also be used in hearing instruments employing a single-element directional microphone with a mechanical switch.

FIG. 2 depicts an exemplary microphone component that may be used in preferred embodiments of the invention. Microphone component 102 may include a first microphone cartridge 126, which is preferably located adjacent a second microphone cartridge 128 along surface 130. In a preferred embodiment, first microphone cartridge 126 may be an omni-directional microphone cartridge, for example, and second microphone cartridge 128 may comprise a directional cartridge. First microphone cartridge 126 preferably includes a front, omni-directional, inlet 132, while second microphone cartridge 128 preferably includes a rear, directional, inlet 134, and a front, directional, inlet 136. Rear inlet 134 preferably further includes an acoustic resistor 138, such as acoustic mesh, through which sound travels. The cross-sectional area of front inlet 136 is preferably in a range of about 0.05 mm² to about 2.0 mm², although not limited thereto.

Microphone component 102 preferably further includes gasket 122, which may be used to seal surface 106 of microphone component 102 within the hearing instrument. This helps to minimize acoustical leaks from the device. Gasket 122 preferably comprises a pressure sensitive adhesive, but is not limited thereto.

Inlets 132, 134, and 136 are preferably located on the same face of the microphone component (e.g., surface 106). Locating them on the same face of the assembly may be advantageous by reducing device size, and improving directionality, sensitivity and signal-to-noise ratio and simplification of the assembly procedure. Sensitivity improvements resulting from the operation and configuration of the inventive hearing instrument device are estimated to be in the range of at least about 14 dB.

Embodiments of the invention may be used for various types of hearing instrument devices, for example, in the ear (ITE), in the canal (ITC), half shell (HS), and behind the ear (BTE) devices. Various circuit types may also be used with the inventive hearing instrument device, including, for example, analog and digital circuits.

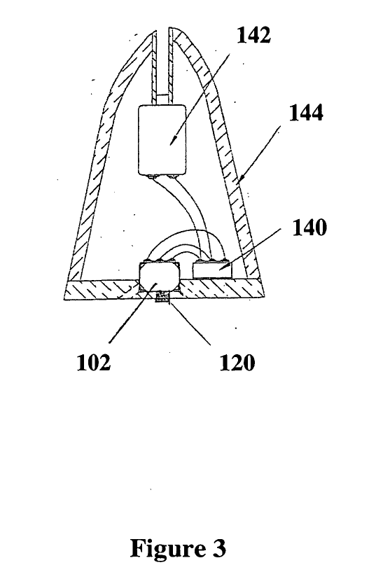

FIG. 3 further depicts a hearing instrument device according to a preferred embodiment of the invention. An electric circuit 140 is operatively connected to the microphone component 102. The electronic circuitry processes an electrical signal from the microphone component representing the received sound. Microphone component 102 is operatively connected to an electrical switch assembly 120 through electric circuit 140, so that the microphone component can be switched between directional mode and omni-directional mode. A receiver 142 is operatively connected to electric circuit 140 to generate an acoustical signal in the user's ear based upon the received sound. A housing 144 preferably surrounds microphone component 102, electric circuit 140 and receiver 142. Faceplate 104 may be mounted on housing 144 to accommodate microphone component 102. Housing 144 may be sized to fit within the ear of a hearing instrument user. The housing may also be configured to be compatible with ITC, HS, and BTE use.

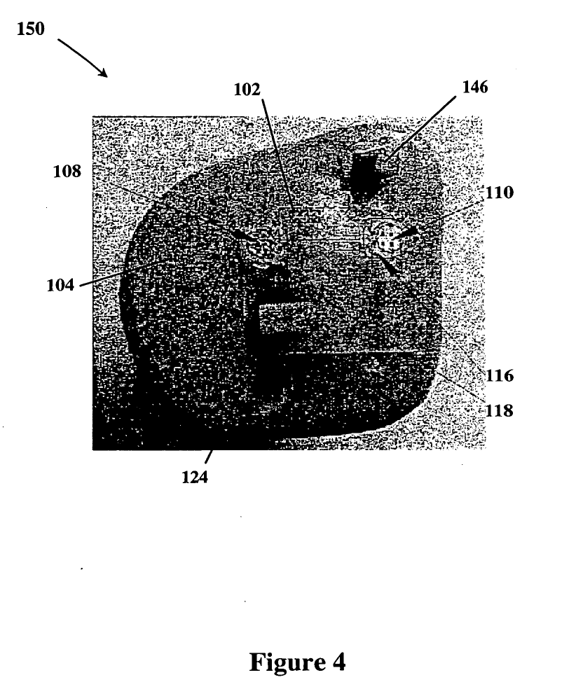

FIG. 4 is a picture illustrating a preferred embodiment of a healing instrument 150. Faceplate 104 is preferably rounded and cosmetically shaped for insertion into the ear. The position of microphone component 102 behind faceplate 104 is illustrated by dashed lines. Ports 108 and 110 may be seen, located behind screens 118 and 116, respectively. Toggle switch 124 of switch assembly 120 is located on the outside of faceplate 104 for access by the user. A volume control 146 may be further included to control the sensitivity of the hearing instrument. For example, volume control 146 may comprise a user tunable potentiometer, operatively connected to electric circuit 140 and/or receiver 142 for control the flow of electric current therein.

While the invention has been described by illustrative embodiments, additional advantages and modifications will occur to those skilled in the art. Therefore, the invention in its broader aspects is not limited to specific details shown and described herein. Modifications, for example, to the layout of the hearing instrument device components and their spacing, may be made without departing from the spirit and scope of the invention. Accordingly, it is intended that the invention not be limited to the specific illustrative embodiments, but be interpreted within the full spirit and scope of the appended claims and their equivalents.

1. A hearing instrument for positioning in the ear of a user comprising:
a faceplate having first and second spatially separated sound openings for receiving sound to be provided to respective inlets of a microphone;
at least one screen partially blocking said first and second spatially separated sound openings and positioned to increase effective distance between said first and second spatially separated sound openings; and
a housing for containing said microphone and electronic circuitry for processing a signal from said microphone representing said received sound, said housing having said faceplate mounted thereon, said housing being sized to fit within the ear of a hearing instrument wearer.

2. A hearing instrument according to claim 1, wherein said screen contain a plurality of holes for admitting sound.

3. A hearing instrument according to claim 1, wherein said screen is placed at a relative angle for improved cosmetics of the hearing aid and reduced size.

4. A hearing instrument according to claim 1, wherein said microphone comprises a plurality of microphone components.

5. A hearing instrument for positioning in the ear of a user comprising:
a faceplate having first and second spatially separated sound openings for receiving sound channeled to respective inlets of a directional microphone and sound received via said first and second spatially separated sound opening also being channeled to an inlet of an omni-directional microphone;
at least one screen partially blocking said first and second spatially separated sound openings and positioned to increase effective distance between said first and second spatially separated sound openings; and
a housing having said faceplate mounted thereon, said housing being sized to fit within the ear of a hearing instrument wearer and containing said omni-directional microphone, said directional microphone and electronic circuitry coupled to said microphones for processing a sound representative signal, said directional microphone inlets and said omni-directional microphone inlet being located on the same surface.

6. A hearing instrument according to claim 5, including a gasket for acoustically isolating said inlets or said directional microphone and said omni-directional microphone.

7. A hearing instrument according to claim 5, including a switch for selecting between an output generated by said directional microphone and an output generated by said omni-directional microphone.

8. A hearing instrument according to claim 5, further comprising an electric circuit and receiver within said housing for receiving electrical signals from said directional microphone or said omni-directional microphone and producing an acoustical signal based on said sound.

9. A hearing instrument according to claim 8, further comprising a volume control for controlling the intensity of said acoustical signal.

10. A hearing instrument comprising:
a faceplate;
a front port in said faceplate for receiving sound therethrough;
a rear port in said faceplate spatially separated from said front port for receiving sound therethrough;
at least one windscreen substantially covering said front port and said rear port and positioned to increase effective distance between said front and rear ports;
a microphone for detecting said sound through said front port and said rear port, said microphone comprising an omni-directional component and a directional component adjacent each other.

11. The hearing instrument of claim 10, wherein said microphone is mounted to said faceplate with a gasket comprising a pressure-sensitive adhesive to substantially seal said microphone within said faceplate to prevent acoustic leaks.

12. The hearing instrument of claim 10, wherein said windscreen contain a plurality of holes for admitting sound.

13. The hearing instrument of claim 10, wherein said windscreen is configured at a relative angle for improved cosmetics of the hearing aid and reduced size.

14. The hearing instrument of claim 10, wherein said omni-directional component and said directional component include a plurality of inlets for receiving said sound, said plurality of inlets being located on a same face of said microphone to reduce the size of said hearing instrument and improve directionality, sensitivity and signal-to-noise ratio of said hearing instrument.
